(19) United States
(12) Patent Application Publication
(10) Pub. No.: US 2003/0231383 A1
(43) Pub. Date: Dec. 18, 2003

(54) Stereomicroscope

(76) Inventor: Heinz Zimmermann, Balgach (CH)

Correspondence Address: HODGSON RUSS LLP, ONE M & T PLAZA, SUITE 2000, BUFFALO, NY, 14203-2391, US

(21) Appl. No.: 10/455,111

(22) Filed: Jun. 5, 2003

(30) Foreign Application Priority Data
Jun. 6, 2002 (DE) 102 25 194.0

(51) Int. Cl. G02B 21/22

(52) U.S. Cl. 359/376

(57) ABSTRACT

Stereomicroscope, particularly a mono-objective stereomicroscope, having an objective changer (2), particularly a revolving objective holder, accommodating at least two objectives (4, 6), wherein by actuating the objective changer (2) the optical axes (4a, 6a) of the objectives (4, 6) can be selectively moved, particularly rotated, into an operative position of the objective, wherein the objective changer (2) comprises a device (3) for rigidly fixing at least one objective (6) in a direction parallel to the optical axis (6a) thereof, and an adjustment device (12, 2a) for adjustably fixing and securing at least one other objective (4) in a direction parallel to its optical axis (4a).

### CROSS REFERENCE TO RELATED APPLICATION

This application claims priority of German patent application 102 25 194.0 filed Jun. 6, 2002, which is incorporated by reference herein.

### FIELD OF THE INVENTION

The present invention relates to stereomicroscopes of a type having an objective changer, such as a rotatable objective holder, accommodating at least two objectives, and to such objective changers for a stereomicroscopes.

### DESCRIPTION OF THE RELATED ART

In conventional light microscopy it is known to use objective changers, e.g. revolving objective holders, to achieve an easily handled alteration or widening of a magnification range, such objective changers having at least two objectives mounted on them which can be brought into alignment by moving or rotating the changer relative to the other optical components.

In order to maintain parfocality, objectives of this kind are mechanically adjusted to a common reference measurement. Parfocality here means an adjustment of different objectives such that a focused point on the object remains sharp when the objective or magnification is changed.

A conventional light microscope with an objective changer is known from U.S. Pat. No. 6,268,958. Two objectives which may be selected are mounted on an objective changer. A first objective mounting element for mounting a first objective is fixed on the objective changer. A second objective mounting element is constructed to be moveable in the direction of an optical axis of the second objective. When ranges of magnification are altered in conventional stereomicroscopes by changing the objectives, it is generally necessary to refocus in order to re-establish the sharp image, requiring some degree of operator input.

This operator input may be reduced, for example, by the use of a revolving objective holder for holding at least two objectives.

Moreover, stereomicroscopes, particularly mono-objective stereomicroscopes are known which are constructed with an objective changer on which fixedly mounted objectives are disposed.

Objective changers for stereomicroscopes of this kind are known, for example, from the Japanese Patent applications published under numbers 1 111 91 11 A and 1 11191 12 A.

However, in the objective changers described therein, there is no discussion of maintaining or guaranteeing parfocality when the objective is changed.

### SUMMARY OF THE INVENTION

The problem of the present invention is to provide an objective changer, particularly a revolving objective holder, for a stereomicroscope wherein there is no need to refocus after changing the objective.

This problem is solved by providing an objective changer for a stereomicroscope that includes means for rigidly fixing at least one objective of the in a direction parallel to the optical axis of the objective, and adjustment means for adjustably positioning at least one other objective in a direction parallel to the optical axis of that other objective.

According to the invention, it is now readily possible to carry out parfocal adjustment of, for example, two objectives in a stereomicroscope, particularly a short focal length and a long focal length objective and to fix this adjustment of the objectives. According to the invention, there is no need for refocusing after changing the objectives or operating the changer.

It is easily possible to equip conventional stereomicroscopes with an adjustable objective changer according to the invention. A stereomicroscope equipped in this manner makes it possible to alternate back and forth between different objectives without the need to focus. The operator comfort of conventional stereomicroscopes in which each change of objective has hitherto involved considerable adjustment is thus improved. Objectives which can be used within the scope of stereomicroscopy can be manufactured with larger tolerances as these tolerances can easily be compensated using the objective changer according to the invention. Thus, using the present invention, the manufacture of stereomicroscope objectives is cheaper than conventional solutions.

Advantageous embodiments of the invention are recited in the subsidiary claims.

According to a preferred embodiment the adjusting device for adjustably fixing an objective comprises an intermediate ring which can be inserted between a carrier of the objective changer and the minimum of one adjustable objective, this intermediate ring being provided on the inside with an accommodating thread for an objective which is to be adjusted and on the outside with an adjustment thread which cooperates with a corresponding mating thread formed on the carrier of the objective changer. With a mechanism of this kind it is possible to achieve mechanically simple and reliable adjustment of an objective on an objective changer in the direction of the optical axis of the objective. The accommodating thread on the inside of the intermediate ring and the adjustment thread on the outside of the intermediate ring are advantageously provided on the same axial or vertical height with respect to the optical axis of the adjustable objective. Thus, the axial or vertical extension of the intermediate ring, which acts as adjustment device, can be kept very small. Thereby, for example a small distance between the adjustable objective and subsequent optical elements of the microscope can be readily realized, whereby for example optical vignetting effects can be minimized.

Conveniently, the adjusting device comprises a clamping mechanism for securing the intermediate ring in a desired position relative to the objective changer. With such a mechanism the position of an objective achieved by rotating the intermediate ring in the mating thread of the fine adjustment thread can easily be fixed.

The intermediate ring expediently comprises at least one bore into which a tool can be inserted for rotating or adjusting the intermediate ring relative to the objective changer. This provides a simple manual means of adjusting the intermediate ring in order to obtain the desired position of the objective relative to the objective changer.

According to a preferred embodiment of the stereomicroscope according to the invention, the clamping mechanism comprises a screw which is rotatable in a threaded recess in the carrier of the objective changer and a resilient clamping element acted upon by this screw, the clamping element being adapted to be brought into engagement with the exterior adjusting thread of the intermediate ring by the action of the screw. This provides a simple and reliable means of fixing the objective in the desired position while ensuring that the adjusting thread is not damaged.

### BRIEF DESCRIPTION OF THE DRAWINGS

The invention will now be explained in more detail with reference to the accompanying drawings, wherein:

FIG. 1 shows a diagrammatic sectional side view of a preferred embodiment of an objective changer according to the invention, and

FIG. 2 shows an enlarged partial sectional view of another preferred embodiment of the objective changer according to the invention.

### DETAILED DESCRIPTION OF THE INVENTION

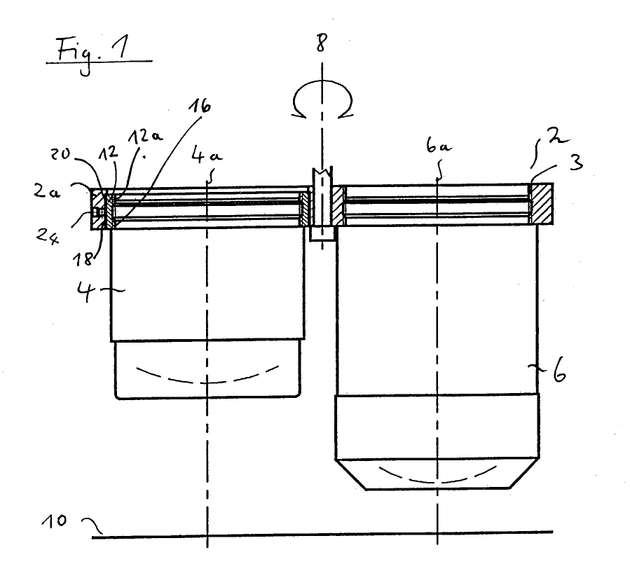

A preferred embodiment of an objective changer of a stereomicroscope according to the invention is generally designated 2 in FIG. 1. To keep the drawings simple the stereomicroscope is not shown in its entirety.

The objective changer 2 carries a first objective 4 and a second objective 6. Let us assume by way of example that the objective 6 provides greater magnification than the objective 4.

The objectives 4 and 6 each have an optical axis 4a and 6a, respectively. The optical axis 4a and the optical axis 6a advantageously extend in parallel to one another, as follows especially from FIG. 1. By rotating about an axis 8 the objectives 4 and 6 can be aligned selectively with an instrument axis (not shown) of the stereomicroscope, so that either the optical axis 4a or the optical axis 6a can be brought into the operative position relative to the instrument axis. By the term instrument axis we mean here an axis running symmetrically parallel between two tube axes (not shown) of the stereomicroscope. The (central) alignment of an objective 4, 6 relative to the instrument axis thus defines the operative position of the objective in the stereomicroscope (operative position of the objective). The object plane of the objectives 4, 6 is designated 10.

In order to achieve a desired focusing the objective changer 2 can be moved along the axis 8; the necessary displacement mechanisms and focusing mechanisms are known per se and need not be shown in detail here.

The objective 6 is screwed into the objective changer 2 until it is fixed, particularly against a stop, a suitable device comprising a thread and a mating thread being diagrammatically shown by general reference numeral 3 in FIG. 1.

The objective 4, on the other hand, is mounted on the objective changer 2 so as to be moveable in the direction of its optical axis 4a, as will be described below.

The Figures show an intermediate ring 12 inserted between a carrier 2a of the objective changer 2 and the objective 4. This intermediate ring comprises an accommodating thread 12a for accommodating the objective 4. The objective 4 is constructed with a corresponding mating thread 16. Expediently, the objective 4 is screwed into the intermediate ring 12, by the cooperation of the threads 12a, 16, until it meets a stop.

On the outside the intermediate ring 12 comprises a fine adjustment thread 18 which interacts with a corresponding mating thread 20 on the carrier 2a. By rotating the intermediate ring 12 and the objective 4 fixedly connected thereto in the mating thread 20 of the carrier 2a it is thus possible to move the objective 4 vertically in the direction of its optical axis 4a.

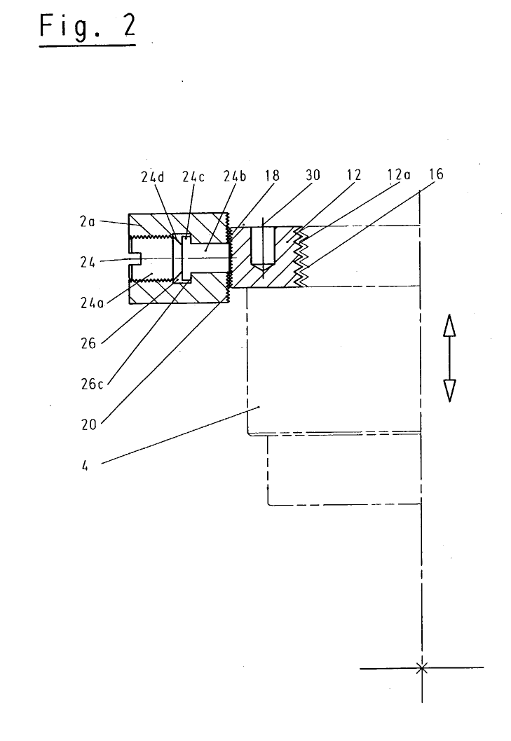

This arrangement is particularly clear from FIG. 2. Here, it especially becomes clear that the threads 12a and 18 of the intermediate ring are advantageously provided at the same axial position with respect to the optical axis 4a of the objective 4. Hereby, the axial or vertical extension of the adjustment system as provided by the intermediate ring and disclosed in the present invention can be kept very small. Thus, a small (axial) distance between the adjustable objective 4 and subsequent optical elements (not shown) can be readily realized, whereby for example optical vignetting effects can be minimized.

According to the embodiment in FIG. 2 no stop is provided for the thread 18 of the intermediate ring 12 on the mating thread 20, thus allowing the objective 4 to be positioned more freely relative to the carrier 2a.

In addition to the components and measures mentioned above, FIG. 2 also has a clamping mechanism generally designated 24 by means of which the selected position of the intermediate ring 12 relative to the carrier 2a can be determined and fixed.

The clamping mechanism 24 comprises a screw 24a which can be screwed into a recess 26 in the carrier 2a formed with a corresponding thread. The screw 24a cooperates with a resilient clamping element 24b. When the screw 24a is screwed in accordingly, this clamping element 24b is thus pressed against the intermediate ring 12 in order to fix the intermediate ring 12 on the carrier 2a and engages in the external thread 18 thereof. The clamping element 24b is usefully made of a resilient material, e.g. a rubber or plastics, so that it is possible to avoid damage to the adjustment thread 18 of the intermediate ring when operating the clamping mechanism.

In all, it is clear that the recess 26 is constructed as a partially threaded through-bore into which the screw 24a and clamping element 24b can be inserted. The through-bore is conveniently formed with a shoulder 26c on which the clamping element which is T-shaped in cross-section abuts with its projection 24c. The point 24d of the screw 24a is chamfered so that the end face of the crew 24a does not act on the clamping element 24b in the region of the annular projection 24c, thereby ensuring that the resilient element 24b is effectively loaded in the direction of the thread 18 or intermediate ring 12. Thanks to this advantageous geometry of the through-bore 26 and clamping element 24b the clamping element 24b can be positioned in the through-bore 26 in such a way that it cannot be lost.

Conveniently, the intermediate ring 12 also comprises a bore 30 into which an adjustment tool can be inserted for rotating the intermediate ring 12 relative to the carrier 2a.

The mode of operation and the advantages which can be obtained with the objective changer according to the invention will now be described by way of example.

First of all, the objectives to be inserted in the carrier 2a are conveniently selected so that their theoretical adjustment length, i.e. the distance between the object plane and a reference point on the associated screw thread of the objectives on the carrier 2a, is substantially identical.

However, mechanical and optical tolerances which may occur both in the stereomicroscope and in the objective may in practice lead to differences in the adjustment length or differences in the focal length of these objectives.

However, the adjustment mechanism described above which uses an intermediate ring 12 makes it easy to compensate any such differences in focal length caused by mechanical or optical tolerances by adjusting one of the objectives in the direction of its optical axis relative to the other objective to achieve parfocality.

After this compensation has been achieved it is possible using the clamping mechanism 24 described above to actuate the intermediate ring 12 in order to define a selected position of the adjusted objective 4.

According to the invention, it is possible to have at least two objectives 4, 6, which were not particularly adjusted to one another from the outset, on a single objective carrier 2 of an objective changer so that parfocality can be guaranteed between the two objectives, i.e. there is no or only minimal readjustment or refocusing after the objective changer has been operated. Conventional stereomicroscopes can easily be fitted with an objective changer of this kind.

Finally it should also be pointed out by way of example that the objective 4 may usefully be vertically adjustable by about ±2 mm by adjusting the intermediate ring.

What is claimed is:

1. A stereomicroscope comprising:
an instrument axis;
an objective changer (2) for accommodating a plurality of objectives (4, 6) each having a respective optical axis (4a, 6a), the objective changer (2) being operable to position a selected one of said plurality of objectives in an operating position with respect to the instrument axis of the stereomicroscope;
wherein the objective changer includes means for rigidly fixing at least one objective (6) of the plurality of objectives in a direction parallel to the optical axis (6a) of thereof, and adjustment means for adjustably positioning at least one other objective (4) of said plurality of objectives in a direction parallel to the optical axis (4a) thereof.

2. The stereomicroscope according to claim 1, wherein the objective changer (2) includes a carrier (2a) having an internal mating thread (20), and the adjustment means comprises an intermediate ring (12) between the carrier (2a) and the at least one other objective (4), the intermediate ring having an internal accommodating thread for the at least one other objective (4) and an external adjusting thread (18) which co-operates with the mating thread (20) of the carrier (2a).

3. The stereomicroscope according to claim 2, wherein the adjustment means further includes a clamping mechanism (24) for securing the intermediate ring (12) in a desired position relative to the carrier (2a).

4. The stereomicroscope according to claim 2, wherein the intermediate ring (12) comprises at least one bore (30) into which a tool can be inserted for adjusting the intermediate ring (12) relative to the carrier (2a).

5. The stereomicroscope according to claim 3, wherein the clamping mechanism (24) comprises a screw (24a) which can be rotated in a threaded recess (26) in the carrier (2a) of the objective changer (2), and a resilient clamping element (24b) on which the screw (24a) acts, the clamping element being adapted to be brought into engagement with the external adjusting thread (18) of the intermediate ring (12) when acted upon by the screw (24a).

6. An objective changer for a stereomicroscope, the objective changer accommodating a plurality of objectives (4, 6) each having a respective optical axis (4a, 6a), the objective changer comprising:
a carrier (2a) having an internal mating thread (20);
means for rigidly fixing at least one objective (6) of the plurality of objectives in the direction of the optical axis (6a) thereof relative to the carrier (2a); and
adjustment means for adjustably positioning at least one other objective (4) of the plurality of objectives in a direction parallel to the optical axis (4a) thereof relative to the carrier (2a).

7. The objective changer according to claim 6, wherein the adjustment means comprises an intermediate ring (12) having an internal accommodating thread (12a) for the at least one other objective and an external adjusting thread (18) which co-operates with the mating thread (20) of the carrier (2a).

8. The objective changer according to claim 6, wherein the adjustment means further includes a clamping mechanism (24) for securing the intermediate ring (12) in a desired position relative to the carrier (2a).

9. The objective changer according to claim 7, wherein the intermediate ring (12) comprises at least one bore (30) into which a tool can be inserted for adjusting the intermediate ring (12) relative to the carrier (2a).

10. The objective changer according to claim 8, wherein the clamping mechanism (24) comprises a screw (24a) which can be rotated in a threaded recess (26) in the carrier (2a) of the objective changer (2), and a resilient clamping element (24b) on which the screw (24a) acts, the clamping element being adapted to be brought into engagement with the external adjusting thread (18) of the intermediate ring (12) when acted upon by the screw (24a).
